(19) United States
(12) Patent Application Publication
(10) Pub. No.: US 2022/0318816 A1
(43) Pub. Date: Oct. 6, 2022

(54) SPEECH, CAMERA AND PROJECTOR SYSTEM FOR MONITORING GROCERY USAGE

(71) Applicant: Sous Technologies Inc., Austin, TX (US)

(72) Inventor: Mohammed Ashour, Austin, TX (US)

(21) Appl. No.: 17/652,605

(22) Filed: Feb. 25, 2022

Related U.S. Application Data
(60) Provisional application No. 63/200,833, filed on Mar. 31, 2021.
(60) Provisional application No. 63/265,210, filed on Dec. 10, 2021.

(51) Int. Cl. G06Q 30/00; G06Q 10/08

(52) U.S. Cl. CPC G06Q 30/018; G06Q 10/087

(57) ABSTRACT

Systems and techniques for food storage inventory management are described herein. For example, a management system of a food storage area management system may detect, via a camera of a device, an item entering the food storage area. One or more cameras of the device may, in some examples, capture an image associated with the item entering the food storage area. In response to capturing the image, the management system may identify the item. In some cases, the management system may then display, via a projector of the device and on a surface of the food storage area, a notification associated with the item.

This application claims priority to U.S. Provisional Application No. 63/200,833, filed on Mar. 31, 2021 and U.S. Provisional Application No. 63/265,210, filed on Dec. 10, 2021, the entire contents of which are incorporated herein by reference.

### BACKGROUND

Refrigerators and other food-storage areas, including pantries and freezers, by which users may store perishable food items provide such users with numerous benefits and opportunities. For example, users are able to extend shelf life for items which may rapidly expire if left unrefrigerated. However, users often forget about or do not know how to use foods left in the refrigerator, resulting in expired and wasted food. Further, the restaurant and foodservice industry is highly competitive and operates with slim margins. Food waste, aside from representing an environmental concern for these businesses, has a tremendously adverse impact on profitability. Thus, users may wish to maximize usage of their refrigerated food.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example block diagram of a management system for monitoring food storage area use.

FIG. 2A illustrates an example refrigerator device coupled to a refrigerator.

FIG. 2B illustrates example refrigerator devices coupled to a refrigerator.

FIG. 2C illustrates example device coupled to a cupboard.

FIG. 2D illustrates example device coupled to a pantry.

FIG. 3 illustrates an example refrigerator device.

FIG. 4 illustrates an example refrigerator device projecting a notification onto a front of a refrigerator.

FIG. 5 illustrates an example counter-top device usable to present notifications.

FIG. 6 illustrates an example process for monitoring food storage area use.

FIG. 7 illustrates another example process for monitoring food storage area use.

FIG. 8 illustrates an example process for another example process for monitoring food storage area use.

FIG. 9 illustrates an example process for monitoring food storage area use.

FIG. 10 illustrates another example process for monitoring food storage area use.

FIG. 11 illustrates an example process for another example process for monitoring food storage area use.

FIG. 12 illustrates an example system that may implement the techniques described herein according to some implementations.

FIG. 13 illustrates an example system that may implement the techniques described herein according to some implementations.

### DETAILED DESCRIPTION

This disclosure includes techniques and implementations for a system for monitoring food storage areas, including refrigerator usage. As described above, food waste is a significant problem in not just households, but commercial food service industries, resulting in significant adverse financial and environmental impacts. While restaurants have many solutions to help automate product ordering, there are no current available solutions that allow restaurants to intelligently track their existing inventory by perishability or provide restaurants with predictive analytics concerning the rate of consumption of items for better assortment and inventory management. The present invention provides a solution to this waste through a smart inventory tracking, management, and optimization system for perishable and non-perishable food items, thus reducing the financial and environmental losses associated with avoidable food waste in households and restaurants. Furthermore, integration of this system with application programming interfaces (APIs) to grocery stores and food service vendors allows for real-time grocery suggestions, incentives, and automated ordering and food replenishment.

For example, as discussed herein, the system may include a portable device that may be coupled to a refrigerator. The device may be physically coupled to a refrigerator and may be connected to a network to utilize, among other technologies: computer vision, barcode scanning technology, thermal and optical image recognition, speech and voice-recognition, and sensors to accomplish various functions. For example, the system may perform autonomous inventory tracking, such as providing a notification when certain items are depleting. In other examples, the system may perform autonomous inventory management. For example, a user may configure the device to automatically replenish specific items in response to determining that the item has fallen below a predetermined threshold. For instance, the device may send a request to a third party, such as a grocery store, to order a new item to replace an expiring or used item.

In some examples, the system may perform semi-autonomous inventory management. For instance, the device may alert a user when the inventory of an item falls below a threshold. Additionally, the device may prompt the user to execute an action, such as ordering more of the item. The system may also, in some examples, alert the user of a probability that the item will perish based on a slower consumption pace relative to an expiration date of the item, and may recommend liquidation options.

In some examples, the system may include inter-device communication between intranet or internet-connected devices within the same network, such as, to name an example, the same kitchen. This may allow for communication between multiple storage environments, enabling coordination of inventory management. In some instances, the device may be configured to wirelessly communicatively couple to other devices within the same proximate environment (e.g. each shelf on a fridge can carry a single device), between proximate environments (e.g. device mounted in the fridge vs. secondary freezer or pantry) and between distant environments (e.g. between the fridge of user and Neighbor fridge a few houses down). In some cases, individual devices may contain all or a subset of the aforementioned technologies.

In some examples, the system may include inventory-based intelligent and/or machine learned meal planning and recipe suggestions. In some cases, the system may determine a total calories consumed per day and provide insights to the user on their household consumption rates relative to baseline or preference established by user against, for example, an established user daily calorie consumption (such as 2000 calories a day). In some instances, the system may determine total calories consumed by the household in a given day and provide guidance on how to reach this target. For example, the system may recommend recipes to the user which can result in meals cooked at or below caloric thresholds, taking into consideration certain dietary and culinary preferences. The system may, for instance, alert the user that 150 calories may be eliminated from a meal—with no meaningful impact on flavor or recipe, such as by the user authorizing the purchase of margarine to replace butter. With the user's permission, the system may automatically place an order via a user account with a third-party vendor.

In some examples, the device may be coupled to a refrigerator. The device may detect, via one or more cameras of the device, an item entering the refrigerator. The one or more cameras may be, for example, red-green-blue image devices, infrared image devices, thermal devices, optical devices, lidar devices, radar devices, to name a few non-limiting examples. The device may then capture, via the one or more cameras, an image associated with the item entering the refrigerator. In response to capturing the image, the device may identify the item and the quantity of the item available. For example, the device may capture optical and thermal images of a carton of milk and utilize a machine learning algorithm either locally via a graphical processing unit, or upload the image data to the cloud where it would be processed. In this example, the optical and thermal image data would be processed to identify the item (e.g. accurately labeling it a carton of milk) and to determine the remaining quantity of the item (e.g. comparing the level of milk in the carton obtained via thermal data to a previous image of the same item to determine the quantity consumed and the quantity remaining). In some examples, the management system may generate a notification associated with the item. The notification may include nutrition information regarding the item (e.g., calories, ingredients, health benefits, etc.), suggested recipes, and a quantity of the item, to name a few non-limiting examples. The device may then, via a projector, display the notification associated with the item on a door of the refrigerator or via an alert wirelessly sent to an application associated with the device. However, in other examples, the notification may be displayed on various other surfaces, such as an inside of the refrigerator, a floor, a wall, or other surfaces, to name a few non-limiting examples.

In some examples, the device may be wirelessly coupled to one or more additional user devices, such as a mobile device and/or a countertop device. For example, the management system may send the notification to the user device(s), which may include a display screen. In response to receiving the notification, the user device(s) may display the notification. In some examples, an application may be associated with the user devices that may allow the user to easily access information relating to the item(s) in the refrigerator. In other examples, the application may allow the user to place orders for new items and access information regarding the item, such as a quantity, item information (e.g., calories, ingredients, health benefits, etc.), and recipes, to name a few non-limiting examples.

In some cases, the device data is available to a user-facing application hosted on a user electric device (such as a smart phone, tablet, personal computer, or the like). In some cases, the application may enable multiple functionalities, such as allowing a user to view a dashboard with insights about inventory levels, arranged according to preferences (e.g. items ordered by expiration date or remaining volume), user can access the devices remotely using the application to determine inventory levels in real time (e.g. user at a grocery store and wants to know if they have enough milk in their fridge), the device can communicate data to the application which may access one or more third party systems via one or more networks to determine meal prep data, such as recipes of meals filtered by items available in the user's storage environments, offering recipe and meal suggestions limited by availability and sorted based on expiration proximity or volume availability, and the like. The devices may also communicate with the application and propose action items like shopping suggestions to either replenish items that are depleting, proposed new items that could be a good add to other items you have in stock to allow a novel recipe trial, or the like. Via API integration to local grocery stores (prompted by an opt-in from the user), the device may also make recommendations for ingredients of food items to purchase that are on sale at a local grocery store as a pairing with existing food materials or to recommend new recipes.

In some examples, the management system may determine, based at least in part on the image associated with the item, an expiration date associated with the item. The device may then compare the expiration date to the current date. Based on comparing the expiration date to the current date, the management system may then determine a number of days until expiration. In some examples, the management system may determine that the number of days until the expiration date is less than a threshold number of days (e.g., 1, 2, 5, 10, etc.), wherein the notification includes the number of days until the expiration date. In this way, the device may alert a user when items are nearing expiration, allowing the user time to replenish stock of the item.

In some examples, the notification may include a suggested recipe including the grocery item. For example, the management system may send item information associated with the identified item to a third-party service, such as a nutrition service. The third-party service may then send, to the management system, a recipe including the item. Thus, the device may suggest recipes for items that are currently in the refrigerator, encouraging the user to use food items the user already has on hand.

In some examples, the management system may automatically order an item when the system determines that the item is running low. For example, based on the image, the management system may determine a quantity of the grocery item. Based on determining that the quantity is less than a threshold quantity, the management system may send, to a third party, a request to purchase the grocery item. In some examples, items may be assigned a tag below a specific volume threshold (e.g. less than 20%) based on user preferences and action steps may be automatically programmed once threshold level is reached or surpassed. For example, the system may alert the user, place an order with a third-party vendor, activate a light or status indicator on the device or some combination of these actions.

In some examples, the management system may include an inventory management system, which may keep an updated record of the inventory of the refrigerator. For example, the image may be a first image, and based on receiving the first image, the management system may determine a first quantity of the item. The management system may then, in some examples, receive an indication that the item has been removed from the refrigerator, and an indication that the item has been returned to the refrigerator. Based on receiving the indication that the item has been returned to the refrigerator, the management system may receive, from the one or more cameras of the device, a second image associated with the grocery item. Based at least in part on the second image, the management system may then determine a second quantity of the grocery item. The management system may then update the inventory management system based on the second quantity of the grocery item. In some examples, the notification may include the second quantity of the item, allowing users to easily view the quantity of items in the refrigerator. In some cases, the system is designed to wake up every time the environment is “active” (e.g. when fridge or pantry door is opened by user) and capture footage of items exiting the environment for consumption or entering the environment for storage.

In some examples, the notification may include nutrition information associated with the grocery item. For example, the management system may display, on the door of the fridge and/or via the user device(s), information associated with the item such as calories, ingredients, and dietary restrictions, to name a few examples.

In some instances, the system may, on a local server or built-in memory, delete all photographs or videos captured by default unless user specifically opts-in to uploading and capturing the images. In other cases, the data captured and/or determined may be stored on a cloud-based service. For example, the data is stored locally or uploaded to cloud servers after a preterminal period of item. In some cases, the cloud-based services may maintain a profile of user consumption behavior is generated with insights and shared with user.

In some implementations of the system, multiple devices may be connected and with user-permission, allowed to communicate data freely. For example, a storage device may be used in the kitchen and another in the pantry, and both devices communicate inventory levels which—collectively—may be used to produce meal suggestions and recipe ideas based on inventory availability.

In some implementations of the system, a speech and voice-enabled feature is activated via a voice command through a microphone implanted on the device that allows the user to verbally communicate with the device, and for the device, via a speaker, to communicate information auditorily back to the user. For example, a user may use speech to articulate instructions to the device, such as asking the device to add items to the grocery shopping list.

In other instances, the user may verbally communicate to the device the identity of items they are placing inside the fridge due to potential limitations of image processing (e.g., unlabeled food items), such as indicating to the device that the item being placed inside the fridge is a container containing leftover food. In some examples, the device may communicate auditory information to the user (e.g., ask clarifying questions). For example, the device may ask the user to estimate an amount of food within the container (e.g., how many ounces of lasagna are available inside the container), to assist the device in calibration. In some cases, the user may simply ask the device to read out the recipe instructions for a specific meal (e.g., in cases when both of their hands are occupied and they are unable to follow the visual prompts on their device).

In some examples, the management system may utilize a group of networked devices that can be used in a commercial kitchen and food storage areas of a hospitality businesses. For example, the management system may provide chefs with up-to-date inventory tracking and intelligent forecasting. For example, the management system may notify chefs, based on available inventory, how many meals can be created and therefore how many days of food service the restaurant can provide given its existing stock of food items. This allows restaurants to ensure that they never have to disappoint customers that an item is already “sold out.” In some cases, the management system may provide chefs with new recipe recommendations based on inventory items already available at their restaurants, prompting chefs to create and excite guests with new offerings without needing to stock new ingredients. In some examples, the management system may provide an API that interfaces with foodservice ordering and/or delivery platforms, enabling an end-to-end fully automated re-ordering system based on machine learning behavior of the management system driven by consumption patterns and uses over time. In some cases, the management system may provide chefs and/or restauranteurs with recommended ingredients based on seasonal availability, freshness, or special promotions along with commensurate recipe recommendations utilizing these items.

Although references in this disclosure may be made to a household, it is to be understood that the system and methods discussed herein may be implemented at any location in which food and/or beverages are stored, such as restaurants, offices, etc.

Additionally, although devices and systems discussed herein may be referred to as a “refrigerator device” and/or a “refrigerator system” it is to be understood that the devices and systems may be implemented into any environment that may store food and/or beverages (e.g., a food storage area), such as, for example, cupboards, pantries, etc.

### Example System Architecture

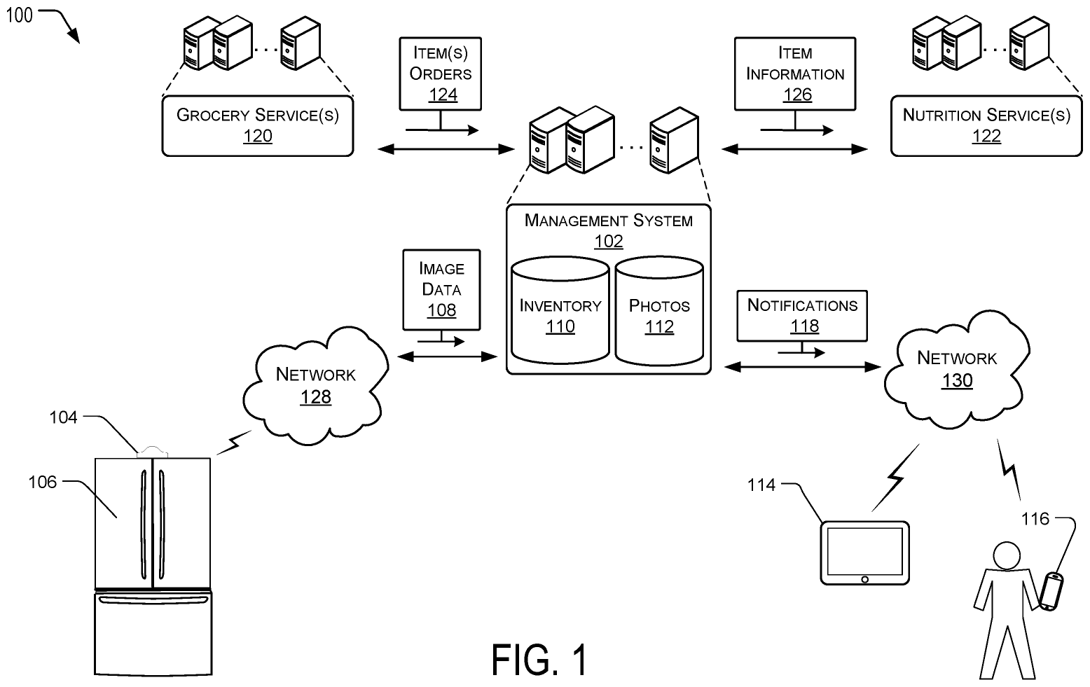

FIG. 1 illustrates an example block diagram 100 of a management system 102 for monitoring refrigerator usage. For example, a refrigerator device 104 may be coupled to a refrigerator 106. The device 104 may be coupled via magnets and/or adhesive, to name a few examples, and may be encased within a temperature resistant cover. The device may be battery-powered or operated through a constant power supply. The device 104 may contain one or more cameras (e.g., red-green-blue image devices, infrared image devices, lidar devices, radar devices, and the like) and may be configured to monitor the inventory of the refrigerator 106 and capture image data 108 (e.g., video, images, and the like) associated with the inventory of the refrigerator (e.g., fruit, vegetables, beverages, condiments, etc.). Additionally or alternatively, the device 104 may contain computer vision systems, internet-of-things (IoT), acoustic sensors, contact and pressure sensors, illuminators, projectors, contacting and/or non-contacting radar, and/or barcode scanners, to name a few examples. For example, illuminators and/or projectors may assist in capturing image data 108 by providing infrared and/or visible light at various intensities.

In some examples, the management system 102 may, upon receiving the image data 108, store the image data in a photo module 110. The management system may use the image data 108 received from the device 104 to process the image data 108 using various techniques, such as a machine learned models, to determine inventory, expiration dates, quantity, etc. associated with the inventory within the refrigerator. For example, computer vision capabilities of the device 104 may enable the management system 102 to compute estimated volume, weight, and/or quantity data associated with items in the refrigerator. Additionally, the management system 102 may include an inventory module 112, which may store information associated with items located in the refrigerator 106. For example, upon receiving the image data 108, the management system 102 may update the inventory module 112 to reflect a current quantity of the item.

In some examples, the management system 102 may be configured to communicate with user devices associated with the management system 102, such as a counter-top device 114 and/or a mobile device 116. For example, in response to receiving image data 108, the management system 102 may send, to the counter-top device 114 and/or the mobile device 116, a notification associated with the image data 108.

The notification 118 may contain a variety of information. For example, the management system 102 may communicate with various third parties, such as grocery service(s) 120 and/or nutrition service(s) 122. For example, in response to receiving image data 108, the management system 102 may determine that an item may expire. Based on past usage, the management system 102 may send, to the grocery service(s) 120, an item order 124, which may contain a purchase order for the item approaching expiration. Additionally, the management system 102 may send item information 126 to nutrition service(s) 122. For example, the management system 102 may, in response to receiving image data 108 associated with an item, send information relating to the item to a nutrition service 122, such as a nutritionist or recipe service. The nutrition service 122 may send, to the management system 102, information relating to the item such as nutrition information, suggested recipes incorporating the item, and health benefits associated with the item, to name a few examples.

In some examples, the item information 118 from the nutrition service(s) 122 may be sent as a notification to the counter-top device 114 and/or the mobile device 116. As an illustrative example, the refrigerator device 104 may send, to the management system, image data 108 of carrots. Based at least in part on the image data, the management system 102 may determine that the carrots are nearing expiration. In response to receiving item information 126 for carrots, the nutrition service 122 may send, to the management system 102, a recipe which uses carrots, such as roasted carrots or carrot cake. The management system 102 may send the recipe to the countertop device 114 and/or the mobile device 116, preventing the carrots from going to waste.

In the current example, the image data 108, notifications 118, item orders 124, and item information 126, as well as other data, may be transmitted between various systems using networks, generally indicated by 128 and 130. The networks 128 and 130 may be any type of network that facilitates compunction between one or more systems and may include one or more cellular networks, radio, WiFi networks, short-range or near-field networks, infrared signals, local area networks, wide area networks, the internet, and so forth. In the current example, each network 128 and 130 are shown as separate networks but it should be understood that two or more of the networks may be combined or the same.

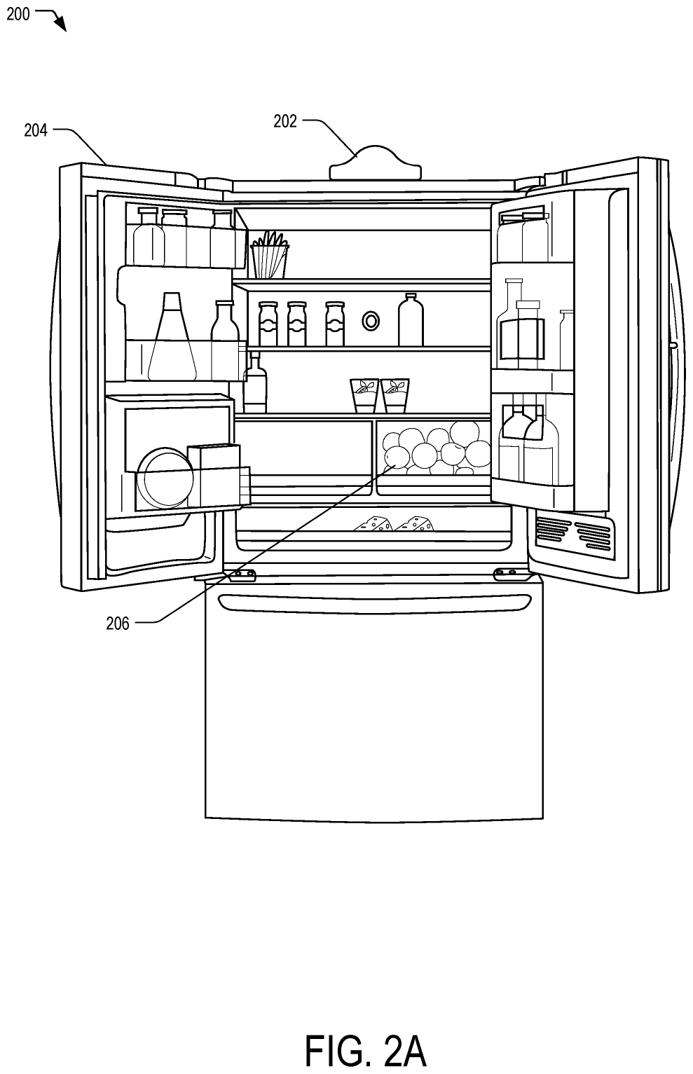

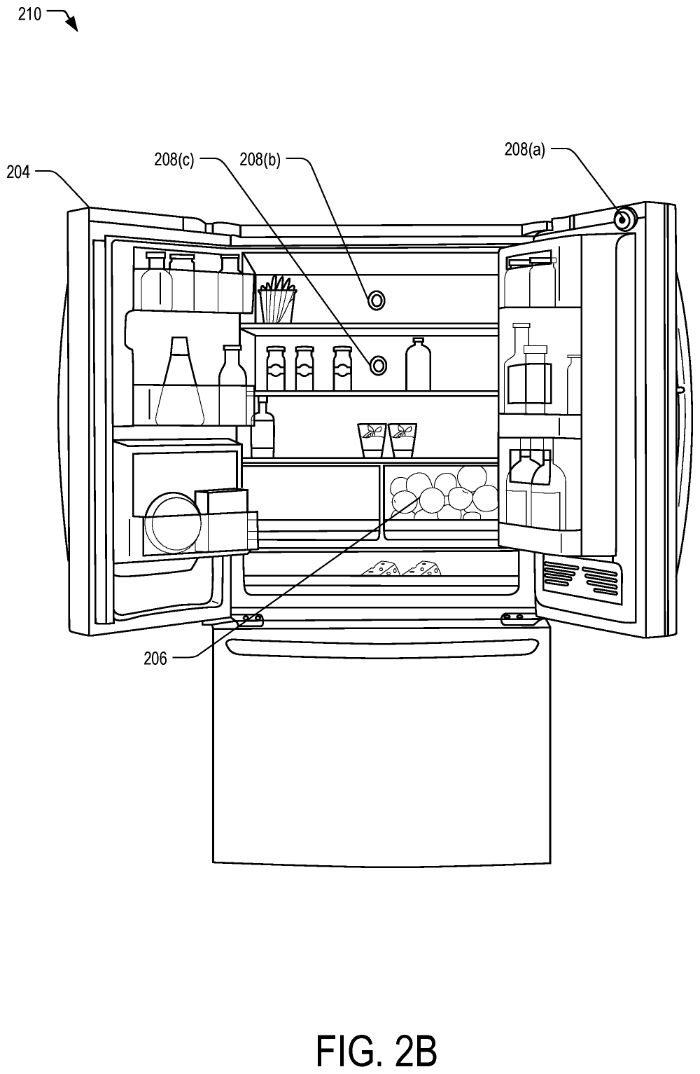

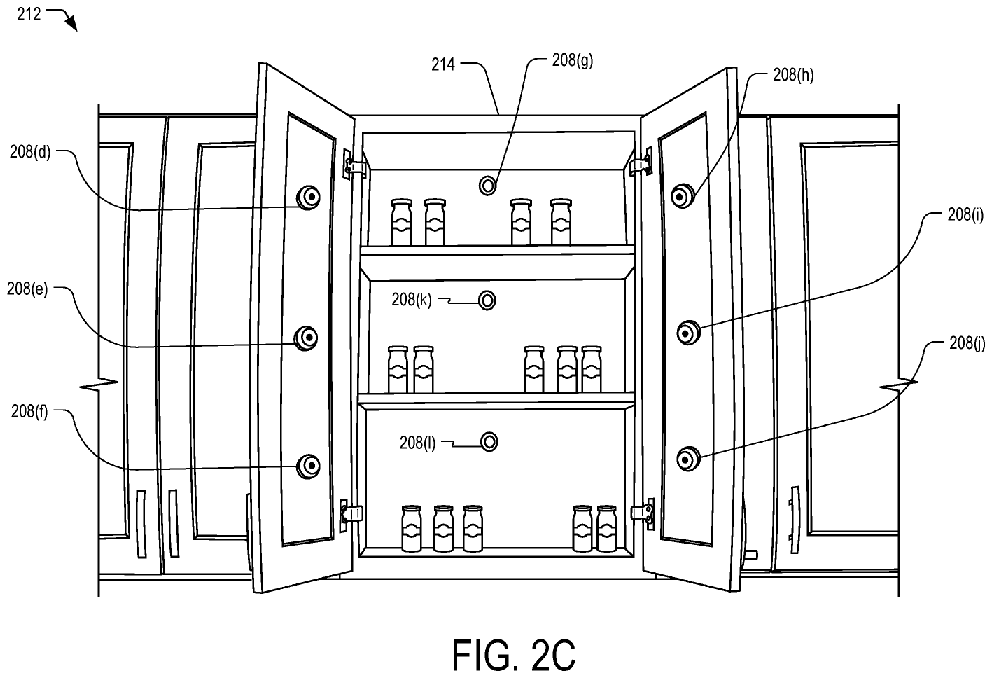

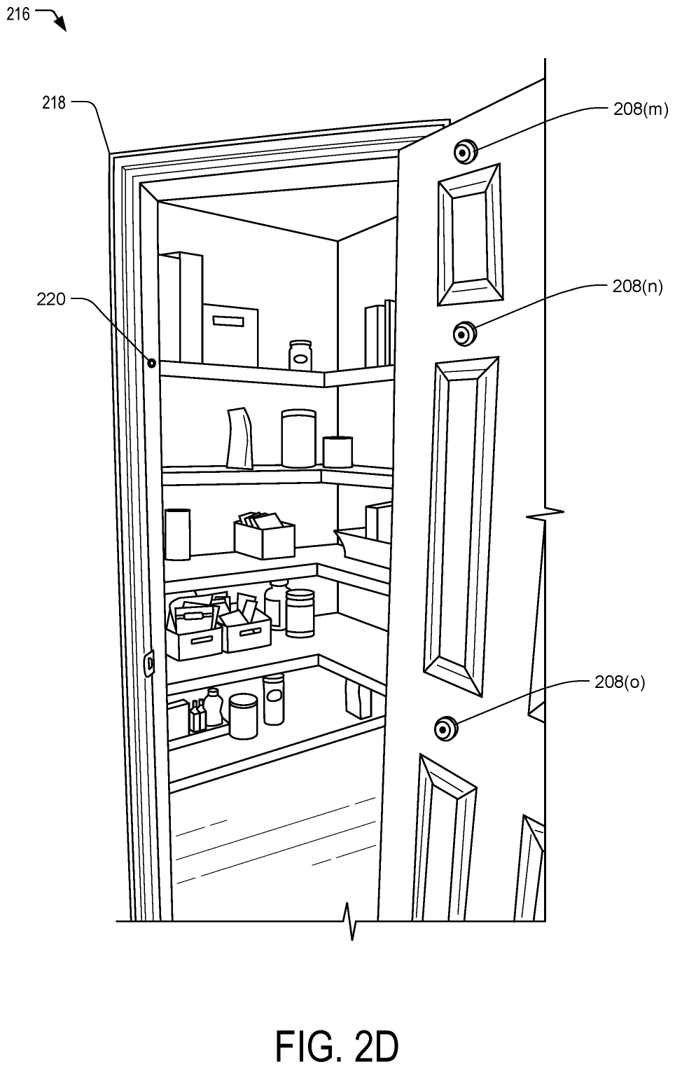

FIG. 2A illustrates an example environment 200 illustrating an example device coupled to a refrigerator. For example, the device 202 may be coupled to a refrigerator 204 to monitor inventory. The device 202 may be located on the refrigerator, such as on the top of the refrigerator 204. However the device 202 may be located at various other locations, such as in the refrigerator 204 or in a direction towards the refrigerator 204. In some examples, the refrigerator 204 may contain one or more items 206 which the device 202 may detect and monitor.

FIG. 2B illustrates an example environment 210 illustrating example devices coupled to a refrigerator. For example, the devices 208(a), 208(b) and/or 208(c) may be coupled to the refrigerator 204 to monitor inventory. The devices 208(a), 208(b), and/or 208(c) may be located in the refrigerator 204, such as on different shelves of the refrigerator 204. However the devices 208(a), 208(b), and/or 208(c) may be located at various other locations, such as on the refrigerator 204 or in a direction towards the refrigerator 204. In some examples, the refrigerator 204 may contain one or more items 206 which the devices 208(a), 208(b), and/or 208(c) may detect and monitor.

FIG. 2C illustrates an example environment 212 illustrating example devices coupled to a cupboard. For example, the devices 208(d), 208(e), 208(f), 208(g), 208(h), 208(i), 208(j), 208(k), and/or 208(1) may be coupled to the cupboard 214 to monitor inventory. The devices 208(d), 208(e), 208(f), 208(g), 208(h), 208(i), 208(j), 208(k), and/or 208(1) may be located in the cupboard 214, such as on different shelves of the cupboard 214. However the devices 208(d), 208(e), 208(f), 208(g), 208(h), 208(i), 208(j), 208(k), and/or 208(1) may be located at various other locations, such as on the cupboard 214 or in a direction towards the cupboard 214. In some examples, the cupboard 214 may contain one or more items which the devices 208(d), 208(e), 208(f), 208(g), 208(h), 208(i), 208(j), 208(k), and/or 208(1) may detect and monitor.

FIG. 2D illustrates an example environment 216 illustrating example devices coupled to a pantry. For example, the devices 208(m), 208(n), and/or 208(o) may be coupled to the pantry 218 to monitor inventory. The devices 208(m), 208(n), and/or 208(o) may be located in the pantry 218, such as on different shelves of the pantry 218 or on a door of the pantry 218. However the 208(m), 208(n), and/or 208(o) may be located at various other locations, such as outside the pantry 218 or in a direction towards the pantry 218. In some examples, the pantry 218 may contain one or more items which the devices 208(m), 208(n), and/or 208(o) may detect and monitor. In some examples, a door opening sensor device 220 may be configured to detect that the pantry 218 door is open and, in response, activate the management system 102 and/or cause the devices 208(m), 208(n), and/or 208(o) to activate.

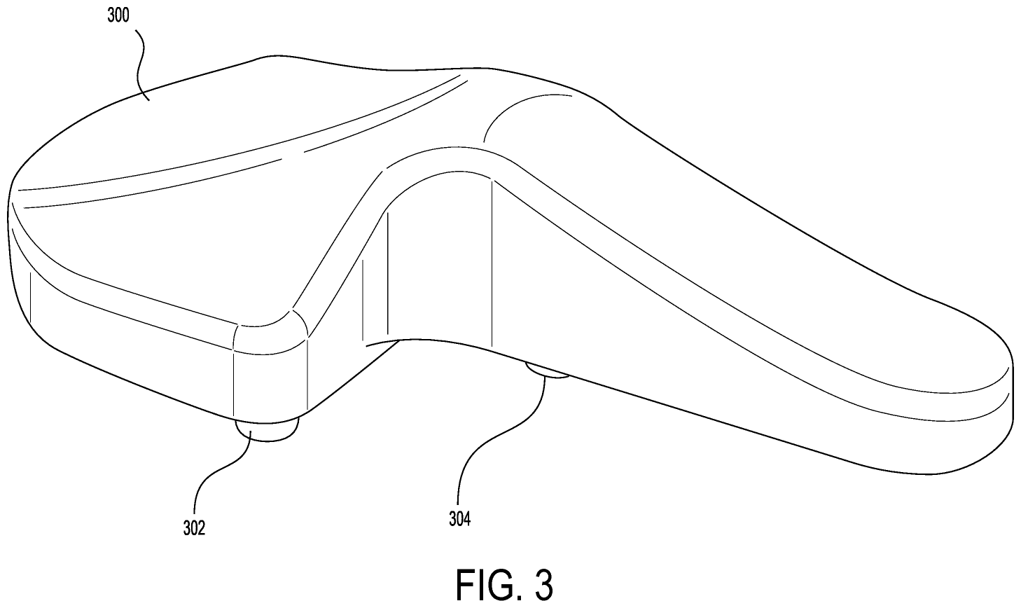

FIG. 3 illustrates an example, device 300. The device 300 may be a portable device that may be coupled to a refrigerator. For example, the device 300 may include one or more magnets 302 to physically couple the device 300. However, in other embodiments, various attachment methods may be used, such as adhesives. In some examples, the device 300 may also include one or more cameras 304 which may capture images entering the refrigerator.

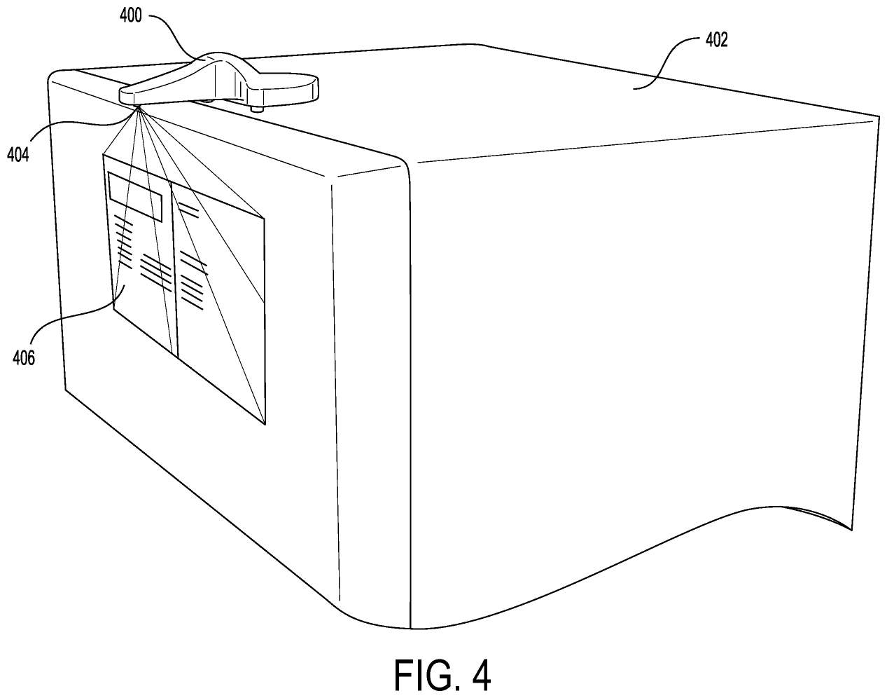

FIG. 4 illustrates an example device 400 projecting a notification onto a front of a refrigerator 402. For example, the device 400 may include one or more projectors 404. The one or more projectors 404 may, upon receiving a notification from a management system of the device 400, project an image of the notification 406 onto the refrigerator 402, thus proving information regarding one or more items in the refrigerator without requiring opening of the refrigerator.

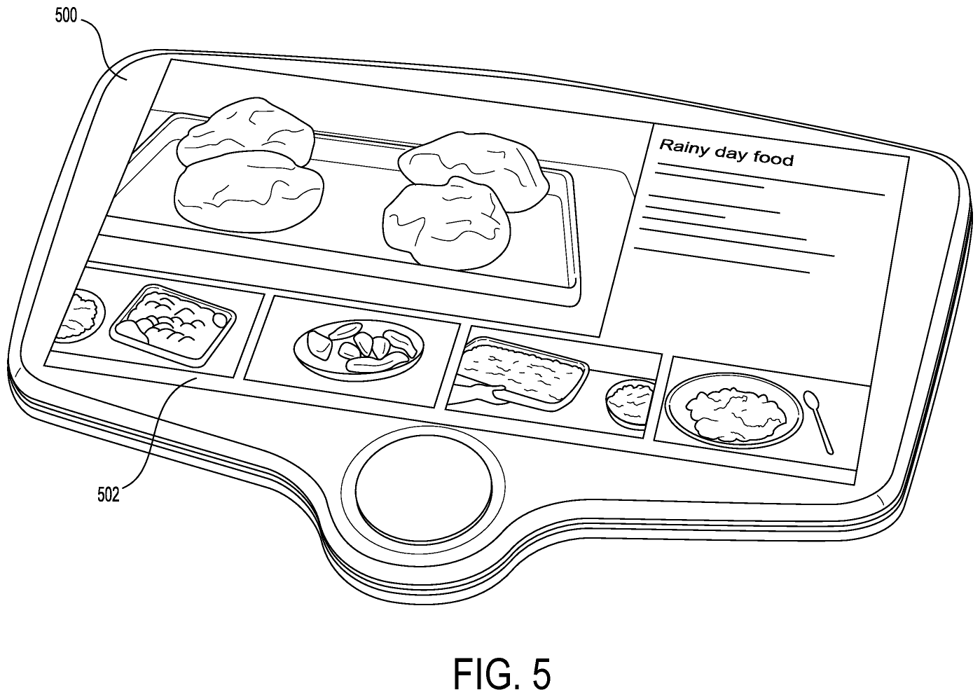

FIG. 5 illustrates an example counter-top device 500 usable to present notifications. The counter-top device 500 may include a display 502, which may include a touch-screen display. Similar to FIG. 4, the management system of the device may send one or more notifications to the counter-top device 500. In some examples, a user may interact with the counter-top device to perform various functions such as accessing an inventory of the refrigerator, viewing nutrition facts associated with items in the refrigerator, locating recipes, customizing meal plans, setting dietary restrictions, and ordering items from third-party vendors, to name a few non-limiting examples.

### Example Methods

Various methods are described with reference to the example system of FIG. 1 for convenience and ease of understanding. However, the methods described are not limited to being performed using the system of FIG. 1 and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. Moreover, the methods described herein can be combined in whole or in part with each other or with other methods.

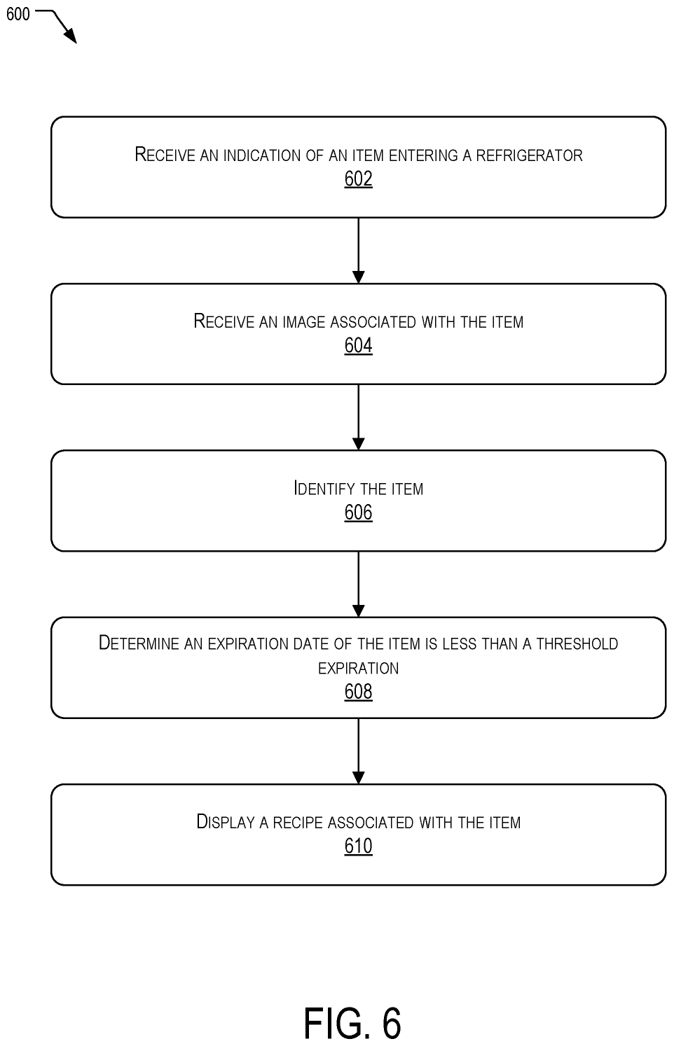

FIG. 6 illustrates an example process 600 for monitoring refrigerator use. For example, at operation 602, the process may include receiving, from a refrigerator device coupled to a refrigerator, an indication of an item entering the refrigerator.

At operation 604, the process may include receiving, from one or more cameras of the refrigerator device, an image associated with the item. The one or more cameras may be, for example, red-green-blue image devices, infrared image devices, lidar devices, radar devices, to name a few non-limiting examples. The refrigerator device may then capture, via the one or more cameras, an image associated with the item entering the refrigerator.

At operation 606, the process may include, in response to receiving the image associated with the item, identifying the item. For example, the refrigerator device may send image data, via a wireless network, to a management system of the device. Using various techniques, such as machine-learned models, the management system may identify the item.

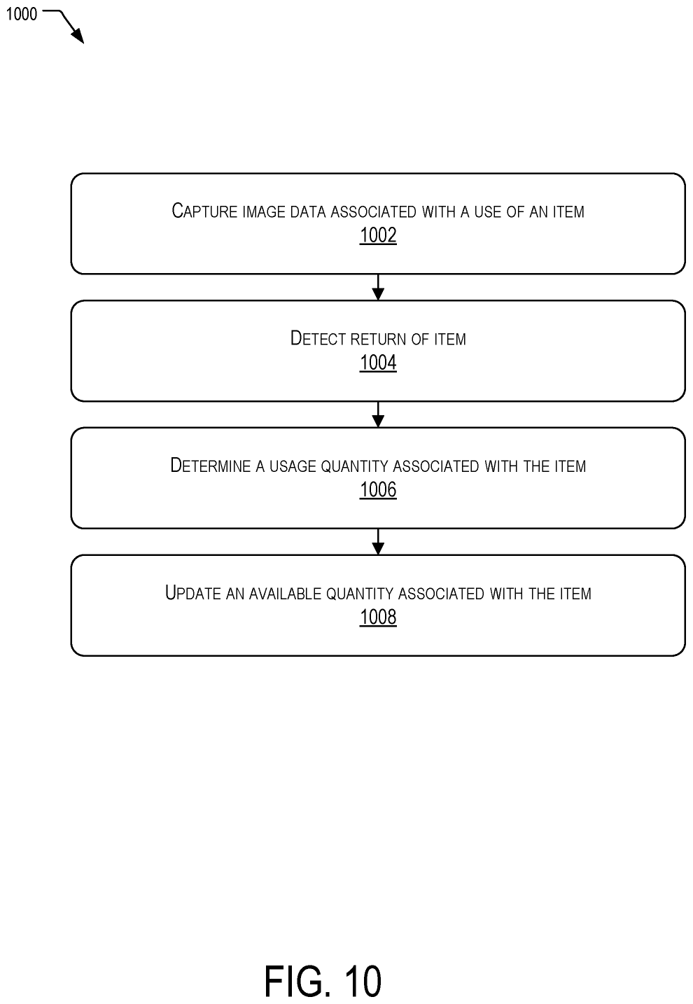

At operation 608, the process may include determining that an expiration date of the item is less than a threshold expiration. For example, as described in FIG. 10, the management system day detect, from the image associated with the item, an expiration date associated with the item. The management system may then determine a current date and compare the expiration date to the current date to determine a number of days until the expiration date (e.g., 1, 2, 3, 5, etc.). Upon determining that the number of days is less than a threshold number of days, the management system may determine that the item is likely to quickly expire.

At operation 610, the process may include displaying, via a projector and onto the refrigerator, or via a user device such as a kitchen-top device or a user device, a recipe associated with the item. In this way, users of the refrigerator device may be prompted and encouraged to use the food that they have on hand, rather than needing to dispose the food after it has expired.

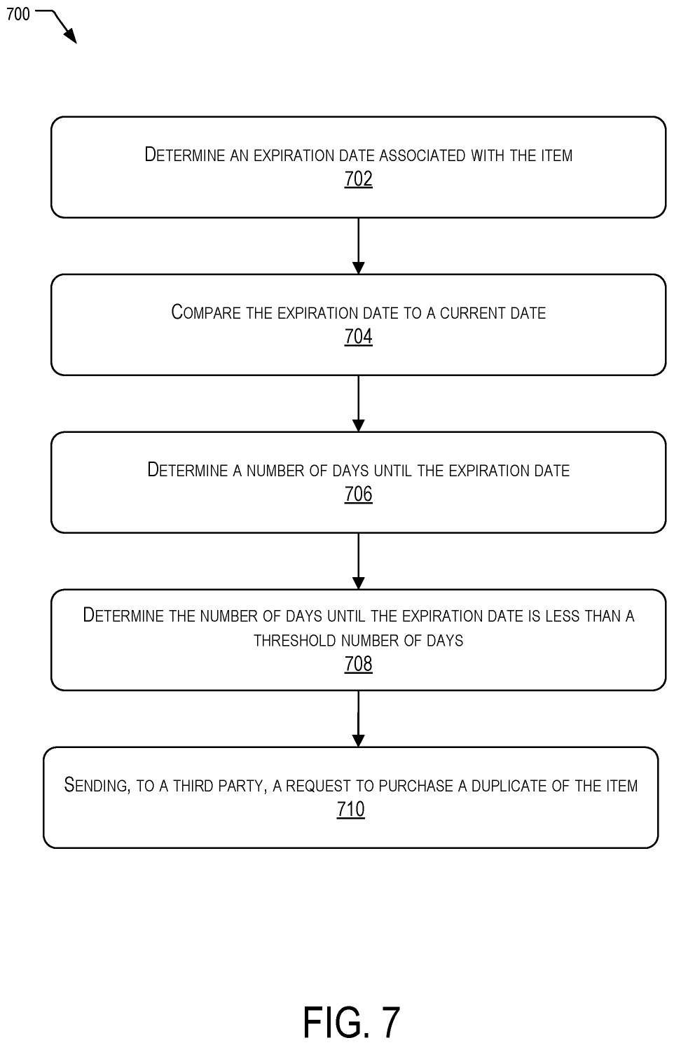

FIG. 7 depicts an example process 700 for ordering a duplicate of an item after detecting that an item may expire. For example, at operation 702, the process may include determining an expiration date associated with the item. For example, a management system of a refrigerator device, using a machine-learned model, may detect a date associated with an expiration date from image data associated with the item.

At operation 704, the process may include comparing the expiration date to a current date. For example, the management system may determine a current date.

At operation 706, the process may include determining a number of days until the expiration date. For example, the management system may compare the expiration date to the current date to determine a number of days until the expiration date (e.g., 1, 2, 3, 5, etc.).

At operation 708, the process may include determining that the number of days until the expiration date is less than a threshold number of days. For example, the management system may determine a threshold number of days (e.g., 1, 2, 3, 5, etc.). In response to determining the threshold, the management system may compare the number of days until the expiration date to the threshold number of days to determine that the number of days is less than the threshold.

At operation 710, the process may include sending, to a third party, a request to purchase a duplicate of the item. For example, the management system may be coupled to a third-party service, such as an online grocery service. In response to determining the number of days until the expiration date is less than the threshold number of days, the management system may predict that the item may expire. Thus, the management system may automatically order a replacement item, ensuring the refrigerator remains stocked.

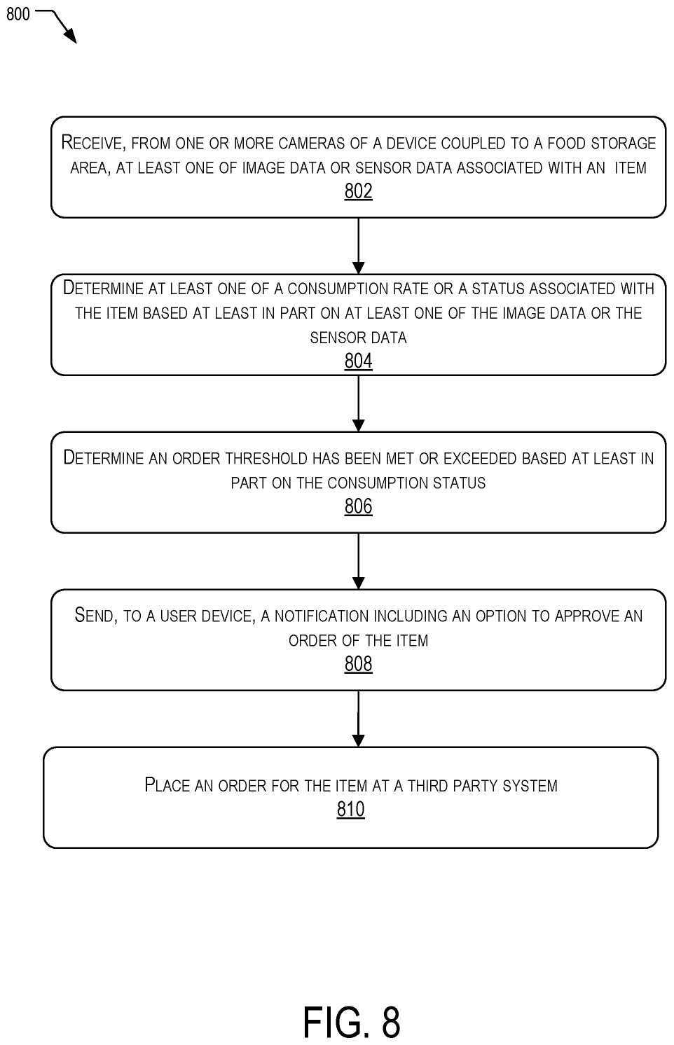

FIG. 8 illustrates an example process 800 for ordering a duplicate of an item based on consumption status. For example, at operation 802, the process includes receiving, from one or more cameras of a device coupled to a food storage area, at least one of image data or sensor data associated with an item. For example, the data image may include an image of the item. Sensor data may include a weight and/or size of the item.

At operation 804, the process includes determining at least one of a consumption rate or a status associated with the item based at least in part on at least one of the image data or the sensor data. For example, the refrigerator device may capture a first image at a first time, a second image at a second time, and a third image at a third time. The management system may compare the first image to the second image to determine a first consumption. The management system may then compare the second image to the third image to determine a second consumption. Based at least in part on the first consumption and the second consumption, the management system may then determine a rate of consumption of the item.

At operation 806, the process may include determining an order threshold has been met or exceeded based at least in part on the consumption status. For example, the order threshold may include a remaining amount of the item (e.g., a percentage amount, a number of subitems, or the like).

At optional operation 808, the process may include at least sending, to a user device, a notification including an option to approve an order of the item. For example, upon detecting that the order threshold has been meet or exceeded, the management system may, in some examples, determine that a user associated the refrigerator device may run out of the item, and may desire to order more of that item. In some examples the user device may be a smartphone device or a tablet, to name a few examples.

At operation 810, the process may include placing an order for the item at a third party system. In some examples, the management system may be commutatively coupled to a third party, such as a grocery store with online-ordering capabilities. Thus, the management system may easily order replacement items to replenish a diminished supply of the item. In some cases, the order amount may be based on an amount input by the user via the user device, a rate of consumption (determined by the management system), prior order history, and the like.

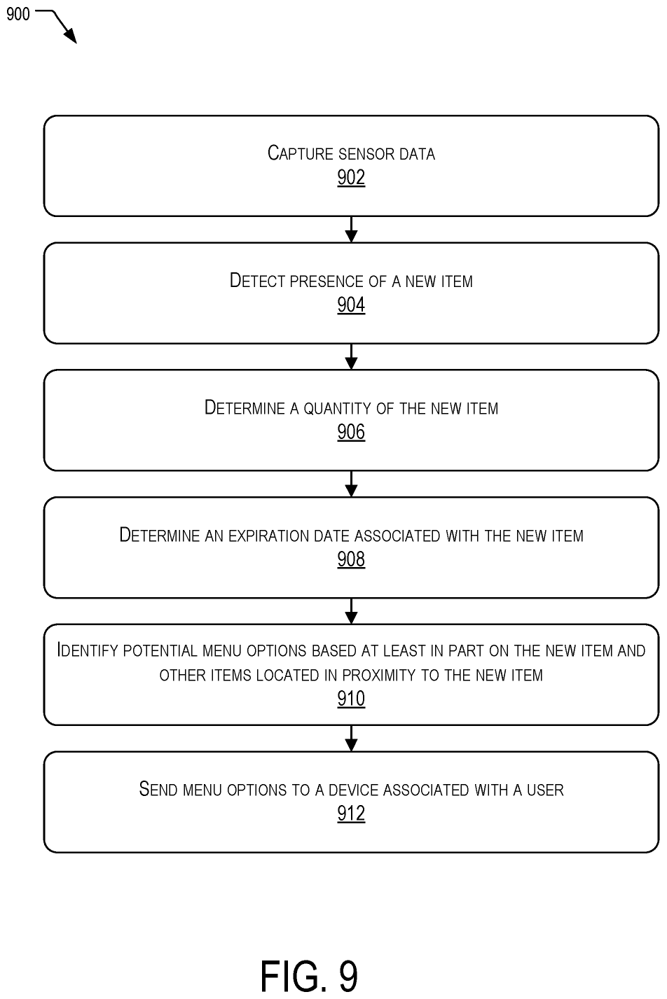

FIG. 9 illustrates an example process 900 for monitoring a refrigerator, a cupboard and/or a pantry use. For example, at operation 902, the process may include capturing, from a device, sensor data. For example, the device may be coupled to a refrigerator, a cupboard and/or a pantry. In some cases the sensor data may be image data, audio data, video data, etc. The device may include cameras such as, for example, red-green-blue image devices, infrared image devices, lidar devices, radar devices, to name a few non-limiting examples.

At operation 904, the process may include detecting the presence of a new item. For example, the new item may be placed in a refrigerator, a cupboard and/or a pantry.

At operation 906, the process may include, determining a quantity of the new item. For example, the refrigerator device may send image data, via a wireless network, to a management system of the device. Using various techniques, such as machine-learned models, the management system may quantify the item.

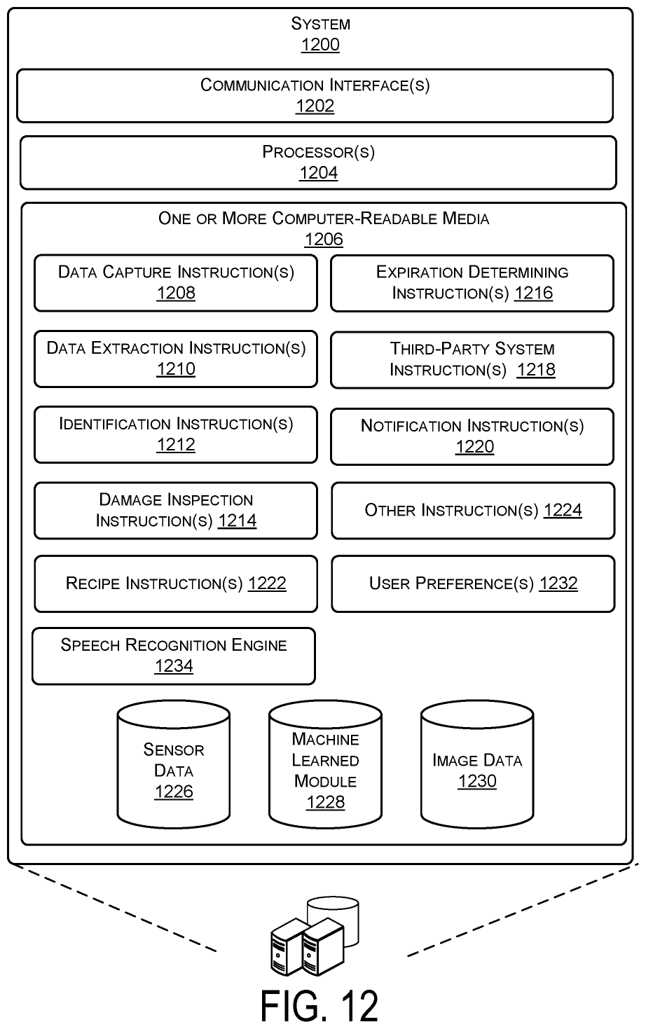

At operation 908, the process may determine an expiration date associated with the item. For example, as described in FIG. 12, the management system day detect, from the image associated with the item, an expiration date associated with the item. The management system may then determine a current date and compare the expiration date to the current date to determine a number of days until the expiration date (e.g., 1, 2, 3, 5, etc.). Upon determining that the number of days is less than a threshold number of days, the management system may determine that the item is likely to quickly expire.

At operation 910, the process may include identifying potential menu options based at least in part on the new item and other items located in proximity to the new item. For example, in some cases, the system may determine a total calories consumed per day and provide insights to the user on their household consumption rates relative to baseline or preference established by user against, for example, an established user daily calorie consumption (such as 2000 calories a day). In some instances, the system may determine total calories consumed by the household in a given day and provide guidance on how to reach this target. For example, the system may recommend recipes to the user which can result in meals cooked at or below caloric thresholds, taking into consideration certain dietary and culinary preferences. The system may, for instance, alert the user that 150 calories may be eliminated from a meal—with no meaningful impact on flavor or recipe, such as by the user authorizing the purchase of margarine to replace butter. With the user's permission, the system may automatically place an order via a user account with a third-party vendor.

At operation 912, the process may include sending menu options to a device associated with a user. In this way, users of the refrigerator device may be prompted and encouraged to use the food that they have on hand, rather than needing to dispose the food after it has expired.

FIG. 10 illustrates an example process 1000 for monitoring a refrigerator, a cupboard and/or a pantry use. For example, at operation 1002, the process may include capturing, from a device, image data associated with a use of an item. For example, the device may be coupled to a refrigerator, a cupboard and/or a pantry. In some cases the sensor data may be image data, audio data, video data, etc. The device may include cameras such as, for example, red-green-blue image devices, infrared image devices, lidar devices, radar devices, to name a few non-limiting examples.

At operation 1004, the process may include detecting the return of the. For example, the item may be removed and then subsequently placed back in a refrigerator, a cupboard and/or a pantry.

At operation 1006, the process may include, determining a usage quantity associated with the item. For example, example, the device may capture a first image at a first time, a second image at a second time, and a third image at a third time. The management system may compare the first image to the second image to determine a first consumption. The management system may then compare the second image to the third image to determine a second consumption. Based at least in part on the first consumption and the second consumption, the management system may then determine a usage quantity associated with the item.

At operation 1008, the process may update an available quantity associated with the item.

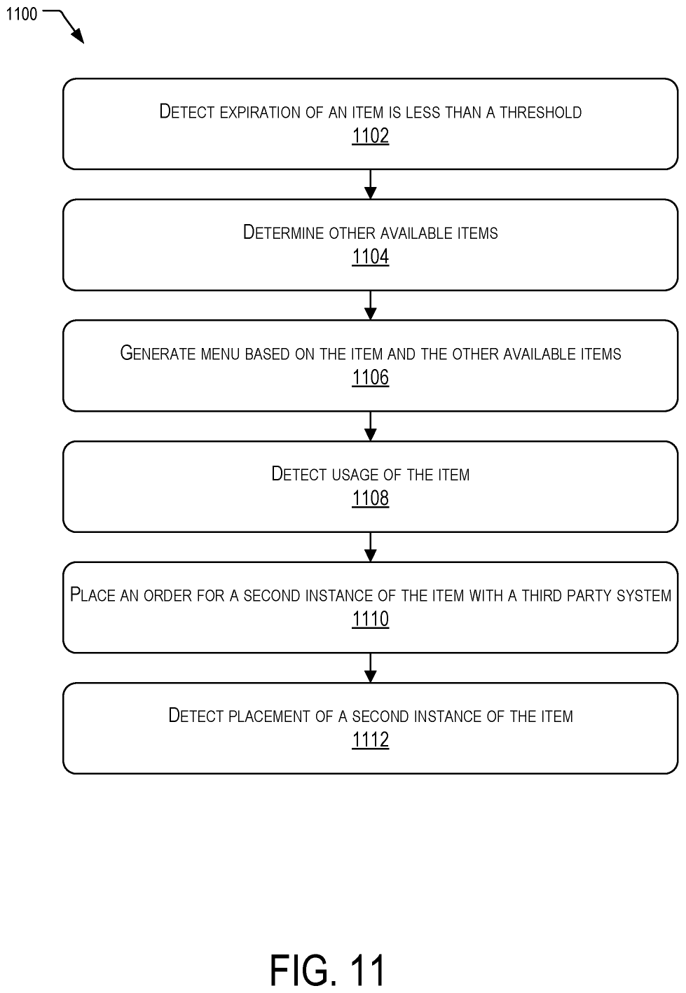

FIG. 11 illustrates an example process 1100 for monitoring a refrigerator, a cupboard and/or a pantry use. For example, at operation 1102, the process may determine that an expiration date of the item is less than a threshold expiration. For example, as described in FIG. 10, the management system day detect, from the image associated with the item, an expiration date associated with the item. The management system may then determine a current date and compare the expiration date to the current date to determine a number of days until the expiration date (e.g., 1, 2, 3, 5, etc.). Upon determining that the number of days is less than a threshold number of days, the management system may determine that the item is likely to quickly expire.

At operation 1104, the process may include determining other available items. For example, the system may identify other items located in proximity to the item that is about to expire.

At operation 1106, the process may include, generating a menu based on the items and the other available items. For example, the management system may send item information associated with the identified item to a third-party service, such as a nutrition service. The third-party service may then send, to the management system, a recipe including the item and the other available items. Thus, the device may suggest recipes for items that are currently in the refrigerator, encouraging the user to use food items the user already has on hand.

At operation 1108, the process may include detecting usage of the item. For example, computer vision capabilities of the device 104 may enable the management system 102 to compute estimated volume, weight, and/or quantity data associated with items in the refrigerator.

At operation 1110, the process may include placing an order for a second instance of the item with a third-party system. For example, the management system may be coupled to a third-party service, such as an online grocery service. In response to determining the number of days until the expiration date is less than the threshold number of days, the management system may predict that the item may expire. Thus, the management system may automatically order a replacement item, ensuring the refrigerator remains stocked.

At operation 1112, the process may include detecting placement of a second instance of the item.

FIG. 12 illustrates an example system that may implement the techniques described herein according to some implementations. The system 1200 may include one or more communication interface(s) 1202 (also referred to as communication devices and/or modems), one or more processor(s) 1204, and one or more computer readable media 1206.

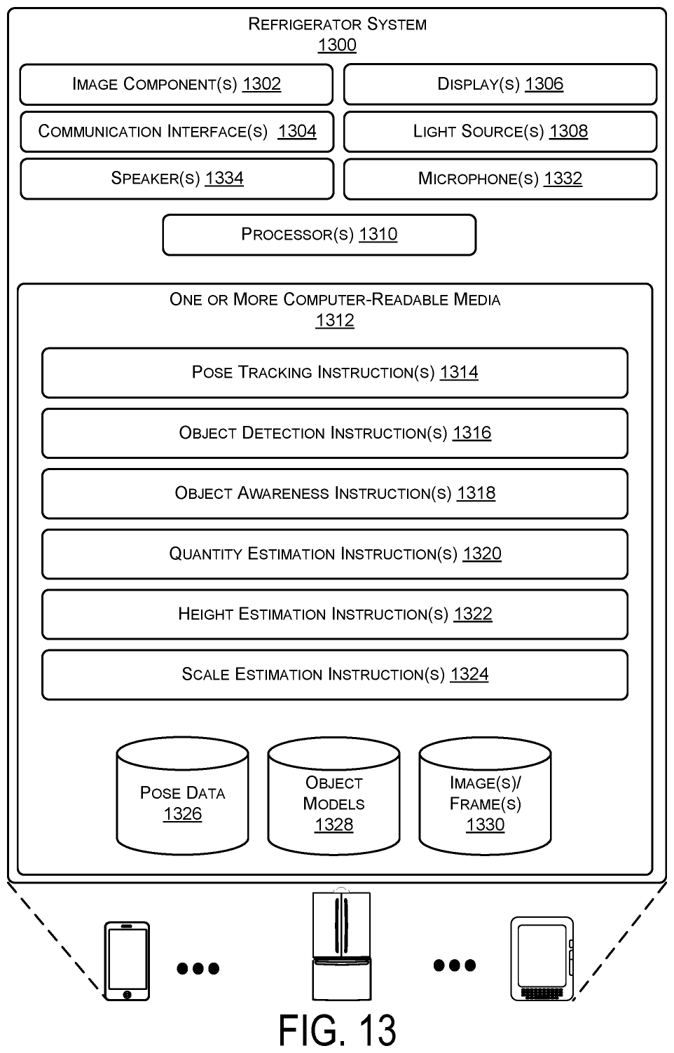

The system 1200 can include one or more communication interfaces(s) 1202 that enable communication between the system 1200 and one or more other local or remote computing device(s) or remote services, such as a sensor system of FIG. 13. For instance, the communication interface(s) 1202 can facilitate communication with other central processing systems, a sensor system, or other facility systems. The communications interfaces(s) 1202 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The system 1200 may include one or more processors 1204 and one or more computer-readable media 1206. Each of the processors 1204 may itself comprise one or more processors or processing cores. The computer-readable media 1206 is illustrated as including memory/storage. The computer-readable media 1206 may include volatile media (such as random access memory (RAM)) and/or nonvolatile media (such as read only memory (ROM), Flash memory, optical disks, magnetic disks, and so forth). The computer-readable media 1206 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Several modules such as instructions, data stores, and so forth may be stored within the computer-readable media 1206 and configured to execute on the processors 1204. For example, as illustrated, the computer-readable media 1206 stores data capture instructions 1208, data extraction instructions 1210, identification instructions 1212, damage inspection instructions 1214, expiration determining instructions 1216, third-party system instruction 1218, notification instructions 1220, recipe instructions 1222, user preferences 1232, a speech recognition engine 1234, as well as other instructions 1224, such as an operating system. The computer-readable media 1206 may also be configured to store data, such as sensor data 1226, machine learned models 1228, image data 1230, as well as other data.

The data capture instructions 1208 may be configured to utilize or activate sensor and/or image capture devices to capture data associated with the item related to the refrigerator. In some cases, the data capture instructions 1208 may select between individual sensor systems based on a temperature, visibility, light, time of day, time of year, physical location, type and/or size of item, type and/or size of item, number of items, and the like.

The data extraction instructions 1210 may be configured to input the captured sensor data 1226 into one or more machine learned models 1228 to generate and/or extract text and data associated with the item. The data may be extracted from a photo and/or sensor data associated with the item.

The identification instructions 1212 may be configured to determine an identity of item. For example, the identification instructions 1212 may utilize one or more machine learned models 1228 with respect to the sensor data 1226 to determine the identification as discussed above. In some cases, the identification instructions 1212 may identify an item based on received input from a user. For example, a user may place an item in a food storage area and the system 1200 may prompt the user to identify the item (e.g., “is the item you placed in the storage area butter or margarine?”). The identification instructions 1212 may then receive input from the user (e.g., a user utterance) indicating identification information associated with the item placed in the food storage area.

The damage inspection instructions 1214 may be configured to input the captured sensor data 1226 into one or more machine learned models 1228 to detect damage with respect to the item. For example, the damage inspection instructions 1214 may detect damage using the machine learned models then compare the damage detected with any known damage to determine if the damage was received while the item was outside the refrigerator.

The expiration determining instructions 1216 may be configured to input the captured sensor data 1226 into one or more machine learned models 1228 to determine an expiration date associated with the item. In some cases, the expiration determining instructions 1216 may be configured to input the captured sensor data 1226 into one or more machine learned models 1228 to determine a date or time the item may expire. In some examples, items may be assigned a tag below a specific volume threshold (e.g. less than 20%) based on user preferences and action steps may be automatically programmed once threshold level is reached or surpassed. For example, the system 1200 may alert the user, place an order with a third-party vendor, activate a light or status indicator on the device or some combination of these actions.

The third-party system instructions 1218 may be configured to select and/or identify various entities which may be associated with the refrigerator device and system. For example, third-party instructions may be sent to third party services, such as nutritionists, recipe banks, and grocery stores, to name a few examples.

The notification instructions 1220 may be configured to alert or otherwise notify a device associated with the refrigerator device, such as the refrigerator itself and/or a user device, such as a counter-top tablet or a mobile deice. For example, the notification instructions 1220 send a notification that an item inventory is running low, that an item may expire, current inventory associated with the item, and item nutrition, to name a few examples. In some cases, the notifications may be sent to a user-facing application hosted on a user electric device (such as a smart phone, tablet, personal computer, or the like). In some cases, the application may enables multiple functionalities, such as allowing a user to view a dashboard with insights about inventory levels, arranged according to preferences (e.g. items ordered by expiration date or remaining volume), accessing devices remotely using the application to determine inventory levels in real time (e.g. a user at a grocery store and wants to know if they have enough milk in their fridge), the system 1200 can communicate data to the application which may access one or more third party systems via one or more networks to determine meal prep data, such as recipes of meals filtered by items available in the user's storage environments, offering recipe and meal suggestions limited by availability and sorted based on expiration proximity or volume availability, and the like.

The recipe instructions 1222 may be configured to provide inventory-based intelligent and/or machine learned meal planning and recipe suggestions. In some cases, the system 1200 may determine a total calories consumed per day and provide insights to the user on their household consumption rates relative to baseline or preference established by user against, for example, an established user daily calorie consumption (such as 2000 calories a day). In some instances, the system 1200 may determine total calories consumed by the household in a given day and provide guidance on how to reach this target. For example, the system 1200 may recommend recipes to the user which can result in meals cooked at or below caloric thresholds, taking into consideration certain dietary and culinary preferences. The system may, for instance, alert the user that 150 calories may be eliminated from a meal—with no meaningful impact on flavor or recipe, such as by the user authorizing the purchase of margarine to replace butter.

In some examples, the recipe instructions 1222 may be configured to provide inventory-based intelligent and/or machine learned meal planning and recipe suggestions based on the user preferences 1232 (discussed in further detail below), third-party data, and/or data captured from grocery items. For example, third party services, such as nutritionists, recipe banks, and/or grocery stores may provide third-party data including health data associated with grocery items (e.g., calorie count, ingredient information, weight information, volume information, etc.). The recipe instructions 1222 may use the third-party data in combination with the user preferences 1232 and grocery item data to generate recommendations to the user for recipes and/or grocery items to be purchased. In some cases, the third-party data and/or the grocery item data may be obtained from one or more grocery stores that have partnered with the system 1200 (e.g., paid a subscription to the system 1200). For example, the grocery stores may provide third-party data and/or the grocery item data (e.g., health characteristic data, nutritional value data, brand data, texture data, calorie data, ingredient information, weight information, volume information, etc.) to the system 1200 to be used in generating recommendations to the user for recipes and/or grocery items to be purchased. In some cases an API integration to local grocery stores (prompted by an opt-in from the user) and the recipe instructions 1222 may generate recommendations for ingredients of food items to purchase that are on sale at a local grocery store as a pairing with existing food materials or to recommend new recipes. In some examples, the management system may provide an API that interfaces with foodservice ordering and/or delivery platforms, enabling an end-to-end fully automated re-ordering system based on machine learning behavior of the management system driven by consumption patterns and uses over time.

In some examples, the recipe instructions 1222 may be configured to utilize a group of networked devices that can be used in a commercial kitchen and food storage areas of a hospitality businesses. For example, the recipe instructions 1222 may provide chefs with up-to-date inventory tracking and intelligent forecasting. For example, the recipe instructions 1222 may notify chefs, based on available inventory, how many meals can be created and therefore how many days of food service the restaurant can provide given its existing stock of food items. This allows restaurants to ensure that they never have to disappoint customers that an item is already “sold out.” In some cases, the recipe instructions 1222 may provide chefs with new recipe recommendations based on inventory items already available at their restaurants, prompting chefs to create and excite guests with new offerings without needing to stock new ingredients. In some cases, the recipe instructions 1222 may provide chefs and/or restauranteurs with recommended ingredients based on seasonal availability, freshness, or special promotions along with commensurate recipe recommendations utilizing these items.

The user preference(s) 1232 may be configured to provide inventory-based intelligent and/or machine learned grocery selection and/or meal planning and recipe suggestions. For example, the user preferences 1232 may be received by the system 1200 via one or more devices, such as the counter-top device 114 and/or the mobile device 116. In some cases, the user preferences 1232 may be learned (e.g., via one or more machine learning algorithms) based on historical records associated with the user and one or more grocery items (e.g., purchase history, item review history, location data, etc.). In some examples, the user preferences 1232 may include an indication of the users taste preferences, health characteristic preferences, nutritional value preferences, brand preferences, texture preferences, meal portion size preferences, number of portion per meal preferences, and the like.

In some examples, the speech recognition engine 1234 may be configured to provide speech recognition functionality. In some implementations, this functionality may include specific commands that perform fundamental tasks like waking up the device, configuring the device, cancelling an input, and the like. The speech recognition engine 1234 may convert a user command to a text string. In this text form, the user command can be used in search queries, or to reference associated responses, or to direct an operation, or to be processed further using natural language processing techniques, or so forth. In other implementations, the user command may be maintained in audio form, or be interpreted into other data forms. As one example, a text form of the user command may be used as a search query to search one or more databases, third party systems, etc. Alternatively, an audio command may be compared to a command database to determine whether it matches a pre-defined command. If so, the associated action or response may be retrieved. In yet another example, the speech recognition engine 1234 may use a converted text version of the user command as an input to a third-party system for conducting an operation, such as ordering a food item, providing information regarding a recipe, and the like.

Any one of these varied operations may produce a response. When a response is produced, the speech recognition engine 1234 transmits the response over the network 128 to the device 104, the device 114, and/or the device 116. In some implementations, this may involve converting the response to audio data that can be played at the device 104, the device 114, and/or the device 116 for audible output through the speaker to the user.

FIG. 13 is an example system 1300 according to some implementations. For example, the system 1300 may include a device that is configured to physical and/or communicatively couple to a refrigerator. In some cases, the system 1300 may be a self-contained. In general, the system 1300 may be configured to implement one or more of the processes discussed above with respect to FIGS. 1-9. In some cases, the system 1300 may utilized multiple process discussed above with respect to FIGS. 1-11 in combination to identify an item.

In the current example, the system 1300 may include image components 1302 for capturing visual data, such as images or frames, from a physical environment. For example, the image components 1302 may be positioned to capture multiple image from substantially the same perspective as the device. The image components 1302 may be of various sizes and quality, for instance, the image components 1302 may include one or more wide screen cameras, 3D cameras, high definition cameras, video cameras, monocular cameras, thermal cameras (e.g., for capturing data usable for determining a volume of an item), among other types of cameras. In general, the image components 1302 may each include various components and/or attributes.

The system 1300 may include one or more communication interfaces 1304 configured to facilitate communication between one or more networks, one or more cloud-based management system, and/or one or more physical objects, such as controller or user device associated with the system 1300. The communication interfaces 1304 may also facilitate communication between one or more wireless access points, a master device, and/or one or more other computing devices as part of an ad-hoc or home network system. The communication interfaces 1304 may support both wired and wireless connection to various networks, such as cellular networks, radio, WiFi networks, short-range or near-field networks (e.g., Bluetooth®), infrared signals, local area networks, wide area networks, the Internet, and so forth. In some instances, the communication interfaces 1304 of the system 1300 may be configured to wirelessly communicatively couple to other devices within the same proximate environment (e.g. each shelf on a fridge can carry a single device), between proximate environments (e.g. device mounted in the fridge vs. secondary freezer or pantry) and between distant environments (e.g. between the fridge of user and Neighbor fridge a few houses down).

In the illustrated example, the system 1300 also includes user device which may include a display 1306, such as a 3D environment display or a traditional 2D display. For instance, in one example, the display 1306 may include a flat display surface, such as a touch screen or LED display, combined with optical lenses configured to allow a user of the system 1300 to view the display 1306 in 3D.

The system 1300 may also include one or more light sources 1308. In some cases, the light sources 1308 may be configured to assist with object, physical environment mapping, presenting information (e.g., menus, recipes, etc.) and/or item tracking. For example, the light sources 1308 may project lines, patterns, or indicators onto objects, such as a front of the refrigerator. In some cases, the light sources 1308 may include one or more projectors.

The system 1300 may also include one or more microphones 1332. In some cases, the microphones 1332 may be usable by the system 1300 to allow for speech dictation and user-instructions.

The system 1300 may also include one or more speakers 1334, in some cases the speakers 1334 may by usable by the system 1300 to read instructions or recipes out loud to allow a hands-free experience and/or to accommodate customers who prefer voice-enabled responses.

The system 1300 may also include one or more processors 1310, such as at least one or more access components, control logic circuits, central processing units, or processors, as well as one or more computer-readable media 1312 to perform the function associated with managing the inventory of the refrigerator. Additionally, each of the processors 1310 may itself comprise one or more processors or processing cores.

Depending on the configuration, the computer-readable media 1312 may be an example of tangible non transitory computer storage media and may include volatile and nonvolatile memory and/or removable and non-removable media implemented in any type of technology for storage of information such as computer readable instructions or modules, data structures, program modules or other data. Such computer readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 1310.

Several modules such as instruction, data stores, and so forth may be stored within the computer-readable media 1312 and configured to execute on the processors 1310. For example, as illustrated, the computer-readable media 1312 store pose tracking instructions 1314, object detection instructions 1316, object awareness instructions 1318, quantity estimation instruction(s) 1320, height estimation instructions 1322, and scale estimation instructions 1324, as well as pose data 1326, object models 1328, and image/frames 1330.

The pose data 1326 may include 6DOF pose data of the item within the physical environment such that the system 1300 may track the 6DOF pose of the item as the item is moved within the refrigerator and surrounding area. The object models 1328 may be 3D models of objects, surfaces, and/or contours within a physical environment that have been mapped or are known. In some cases, the object models 1328 may be generated from image data from the corresponding physical environment while in other cases, the object models 1328 may be generated using data aggregated from a plurality of physical environments (e.g., such as common shapes or objects).

The pose tracking instructions 1314 may be configured to receive the images and/or frames 1330 captured by the image component 1302 to track the 6DOF pose of the item within the physical environment. For instance, the pose tracking instructions 1314 may perform a visual-inertial SLAM technique to track the 6DOF pose of the item.

The object detection instructions 1316 may be configured to identify objects or lines associated with objects within the physical environment surrounding the item. For example, the object detection instructions 1316 may generate a sparse map of points of interest using feature points. The points of interest may then used as inputs to the SLAM associated with the pose tracking instructions 1314. The object detection instructions 1316 includes an obstacle-awareness process to detect line segments from the images and frames 1330 captured by the image components 1302. The object detection instructions 1316 matches the line segments together using one or more descriptor to form lines. As discussed above, the descriptor may be a color variations, gradients, or contrasts between each side of the lines, as lines within a physical environment typically have a dominate color on each side.

Next, the object detection instructions 1316 locates the lines in the physical environment by using pairs of images or frames 1330 captured by the image components 0202 and the 6DOF pose generated by the pose tracking instructions 1314. For example, the object detection instructions 1316 may be parameterized each line using the two 3D points which represent the line's endpoints. For example, the object detection instructions 1316 place or locate each line as the lien is observed in multiple images.

In another example, the object detection instructions 1316 may detect edgelets in addition to or in lieu of detecting lines. As discussed herein, an edgelet is a small patch of an image with high image gradient. For example, detecting edgelets allows for the detection of curved surfaces or contours in addition to those having straight edges. In this example, the object detection instructions 1316 may use the sparse point of interest map and the 6DOF pose generated by the pose tracking instructions 1314. The object detection instructions 1316 may first detect then merge or connect nearby or adjacent edgelets together. In some cases, the object detection instructions 1316 may compute a reprojection error for each edgelet in a contour and reject edgelets that have a reprojection error over a threshold. The joined or connected edgelets are then utilized by the object detection instructions 1316 to estimate surface contours. The surface contours may be used to form surfaces, for instance, by applying a Poisson reconstruction technique.

The object awareness instructions 1318 may be configured to project the lines, surfaces, and/or contours detected by the object detection instructions 1316 into the environment. For example, the object awareness instructions 1318 may cause rays, corner lines, partially transparent walls, or other indicator of the location and size of the object.

The drift correction instructions 1320 may be configured to perform a periodic bundle adjustment or correction to align the item within the environment with the item's actual location in the physical environment. The drift correction instructions 1320 may perform the bundle adjustment to determine a desired 6DOF pose of the item. Next, the drift correction instructions 1320 may then determine a transformation estimate between the desired 6DOF pose and the current 6DOF pose of the item to generate a difference in each of the six degrees of freedom. In some cases, the transformation estimate may include a translation estimate and a rotation estimate. Once the transformation estimate is calculated, when the item moves, the drift correction instructions 1320 may determine a direction of the motion along each of the six degrees of freedom, e.g., the motion in the X direction (left/right), Y direction (up/down), Z direction (forward/backward), as well as the pitch, yaw, and roll of the motion.

If the motion of the item within one of the six degrees of freedom matches one of the six degree of freedom associated with the transformation estimate, the drift correction instructions 1320 may cause an increase or decrease in magnitude or speed associated with the movement along the corresponding degree of freedom.

In another example, the drift correction instructions 1320 may determine a correction vector based on difference between the current 6DOF pose of the item and the desired 6DOF pose. While the item is in motion, the drift correction instructions 1320 may determine an overall magnitude associated with the motion regardless of the degree of freedom. The drift correction instructions 1320 may then calculate a correction motion and apply the correction motion in the direction of the correction vector.

The height estimation instructions 1322 may be configured to establish a height of the item. The height estimation instructions 1322 may first determine surfaces or planes using one more of the processes discussed above. For example, the height estimation instructions 1322 may detect large surfaces or planes that are substantially perpendicular to motion of the item. The height estimation instructions 1322 may then process each of the potential or hypothesis ground planes to determine which is beneath the 6DOF pose of the item.

The scale estimation instructions 1324 may be configured to determine a scale associated with the physical environment to assist with object awareness and avoidance as well as to correctly scale the environment with respect to the item. In one example, the scale estimation instructions 1324 may first select and store a number of keyframe poses that may be used to determine scale from the plurality of frames received as part of the images and frames 1330 captured by the image components 1302. For example, a keyframe pose may be selected based in part on the detection of keypoints within a particular frame. In this example, the scale estimation instructions 1324 may also select and store a number of intermediate poses to provide additional 6DOF poses between keyframe poses. In some cases, the intermediate poses may be captured and stored by the scale estimation instructions 1324 on a periodic basis. The scale estimation instructions 1324 may then remove noise from the keyframe poses and the intermediate posers using a Monet Carlo technique to estimate uncertainty and solve for various parameters.

The scale estimation instructions 1324 may then receive additional images or frames 1330. The scale estimation instructions 1324 may then determine scale by solving a linear system of equations using two or more of the keyframe poses and/or the intermediate poses, and the additional images/frames 1330.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A device comprising:
one or more sensors;
one or more microphones
one or more speakers;
one or more projectors;
one or more communication interfaces to communicate with one or more cloud services, the one or more cloud services including a management system;
one or more processors, and
one or more non-transitory computer-readable media storing instructions, that, when executed by the one or more processors cause the one or more processors to perform operations comprising:
receiving, from the one or more sensors, sensor data associated with an item located in a storage area;
in response to receiving the sensor data associated with the item, identifying the item; and
causing display, via at least one of one or more user devices or one or more projectors on a surface of the storage area, a notification associated with the item.

2. The device as recited in claim 1, the one or more non-transitory computer-readable media instruction further causing the processors to perform operations comprising sending the notification to a user device.

3. The device as recited in claim 1, the one or more non-transitory computer-readable media instruction further causing the processors to perform operations comprising:
determining, based at least in part on the sensor data associated with the item, an expiration date associated with the item;
comparing the expiration date to a current date;
determining, based at least in part on comparing the expiration date to the current date, a number of days until expiration; and
determining that the number of days until the expiration date is less than a threshold number of days,
wherein the notification includes the number of days until the expiration date.

4. The device as recited in claim 3, wherein the notification suggests a recipe including the item.

5. The device as recited in claim 1, the one or more non-transitory computer-readable media instruction further causing the processors to perform operations comprising:
based at least in part on the sensor data, determining a quantity of the item; and
based at least in part on determining that the quantity is less than a threshold quantity, sending, to third party, an order to purchase the item.

6. The device as recited in claim 1 wherein the sensor data is first sensor data, the one or more non-transitory computer-readable media instruction further causing the processors to perform operations comprising:
based on the first sensor data, determining a first quantity of the item;
updating an inventory management system based least on the first quantity of the item;
receiving an indication of removal of the item from the storage area;
receiving an indication of a return of the item to the storage area;
based at least in part on receiving the indication of the return of the item, receiving, from the one or more sensors, second sensor data associated with the item;
based on the second sensor data, determining a second quantity of the item; and
updating the inventory management system based least on the second quantity of the item.

7. The device as recited in claim 1, wherein the notification includes nutrition information associated with the item.

8. A method comprising:
detecting, via a sensor of a device, an item entering a food storage area;
capturing, via the sensor, sensor data associated with the item entering the food storage area;
in response to capturing the sensor data, identifying the item; and
displaying, via a projector of the device and on a surface of the food storage area, a notification associated with the item.

9. The method of claim 8, further comprising sending the notification to a user device.

10. The method of claim 8, further comprising:
determining, based at least in part on the sensor data associated with the item, an expiration date associated with the item;
comparing the expiration date to a current date;
determining, based at least in part on comparing the expiration date to the current date, a number of days until expiration; and
determining that the number of days until the expiration date is less than a threshold number of days,
wherein the notification includes the number of days until the expiration date.

11. The method of claim 8, wherein the notification includes an option to approve an order of the item and the method further comprises placing the order for the item at a third party system.

12. The method of claim 8, further comprising:
based at least in part on the sensor data, determining a quantity of the item; and
based at least in part on determining that the quantity is less than a threshold quantity, sending, to third party, an order to purchase the item.

13. The method of claim 8, wherein the sensor data is first sensor data, the method further comprising:
based on the first sensor data, determining a first quantity of the item;
receiving an indication of removal of the item from the food storage area;
receiving an indication of a return of the item;
based on receiving the indication of the return of the item, receiving second sensor data associated with the item;
based on the second sensor data, determining a second quantity of the item; and
updating an inventory management system based least on the second quantity of the item.

14. The method of claim 8, further comprising:
receiving third-party data associated with nutritional information;
receiving user preference data associated with the item; and
generating a recipe based at least in part on the third-party data and the user preference data, wherein the notification includes the recipe.

15. One or more non-transitory computer-readable media having computer-executable instruction that, when executed by one or more processors, cause the one or more processors to perform operations comprising:
receiving, from one or more cameras of a device coupled to a food storage area, sensor data associated with an item;
determining at least one of: consumption rate or a status associated with the item based at least in part on the sensor data;
determining an order threshold has been met or exceeded based at least in part on at least one of the consumption rate or the status associated with the item;
sending, to a user device, a notification including an option to approve an order of the item; and
placing an order for the item at a third party system.

16. The one or more non-transitory computer-readable media of claim 15, further comprising sending the notification to a user device.

17. The one or more non-transitory computer-readable media of claim 15, further comprising:
determining, based at least in part on the sensor data associated with the item, an expiration date associated with the item;
comparing the expiration date to a current date;
determining, based at least in part on comparing the expiration date to the current date, a number of days until expiration; and
determining that the number of days until the expiration date is less than a threshold number of days,
wherein the notification includes the number of days until the expiration date.

18. The one or more non-transitory computer-readable media of claim 15, further comprising:
receiving, from a third-party system, identification data of least one food item associated with at least one of a sale or a coupon;
identifying at least one recipe including the at least one food item and the item located in the food storage area;
sending a notification to a user device including the recipe based at least in part on user data including at least one of eating habits, previous recipe recommendations, or dietary restrictions.

19. The one or more non-transitory computer-readable media of claim 15, further comprising:
based on the sensor data, determining a first quantity of the item;
updating an inventory management system based least on the first quantity of the item;
receiving an indication of removal of the item from the food storage area;
receiving an indication of a return of the item;
based on receiving the indication of the return of the item, receiving, from the one or more cameras, additional sensor data associated with the item;
based on the additional sensor data, determining a second quantity of the item; and
updating the inventory management system based least on the second quantity of the item.

20. The one or more non-transitory computer-readable media of claim 15, wherein the notification includes nutrition information associated with the item.
